(19) United States
(12) Patent Application Publication
(10) Pub. No.: US 2023/0135199 A1
(43) Pub. Date: May 4, 2023

(54) MAINTENANCE KNOWLEDGE RECOMMENDATION ACROSS DOMAINS

(71) Applicant: Hitachi, Ltd., Tokyo (JP)

(72) Inventors: Hideaki Suzuki, Santa Clara, CA (US); Ahmed Farahat, Santa Clara, CA (US); Adriano Arantes, Santa Clara, CA (US); Chetan Gupta, San Mateo, CA (US)

(21) Appl. No.: 17/517,030

(22) Filed: Nov. 2, 2021

(51) Int. Cl. G06Q 10/06; G06F 16/28; G06F 16/2457

(52) U.S. Cl. CPC G06Q 10/063112; G06F 16/285; G06F 16/24578; G06Q 10/06313

(57) ABSTRACT

Systems and methods described herein involve facilitating a recommendation of materials to users, which can involve determining, from a job profile, a job experience level of a user for a job type and equipment type combination; determining, for each material in a database of materials, the job experience level associated with the each material based on an access log to the each material by one or more users and content of the each material to generate a material profile for each of the job experience level; and generating a recommendation of materials from the database for the user based on the determined job experience level of the user and the job experience level associated with the each material.

### BACKGROUND

### Field

The present disclosure is generally directed to maintenance systems, and more specifically, to systems and methods that facilitate maintenance knowledge recommendations across domains.

### Related Art

Maintenance is an important task for maintaining equipment operation. Maintenance workers who conduct maintenance work need to acquire various knowledge related to maintenance in order to carry out inspections, maintenance, and repairs. Therefore, it can take significant time and cost to train experienced maintenance workers.

In general, to train a maintenance worker, both knowledge acquisition on the desk and practical training in the field are necessary, and it is important to enhance educational materials for that purpose. Learners proceed with learning while referring to educational materials and reference materials to make up for the lack of knowledge. However, in situations in which there is a lack of knowledge, there can be difficulty in determining what materials exist to assist and where they can be located. In addition, support from instructors can be indispensable because there is no knowledge of what technical terms should be used for searching. Further, most of the training materials are not available in a digitized format which makes them difficult to navigate and search.

Related art implementations use the following types of systems to facilitate knowledge.

Search engine: A user is requested to input appropriate keywords to access desired information. If the right keywords are not specified, then the desired outputs will not be obtained.

Hyper link: Each document has keywords which are linked to other documents. A user cannot choose any other options to refer related information.

Keyword completion: Once a keyword is input by a user in search engine system, the system recommends related keywords to use with the original keyword.

Sub menu: A user can choose multiple menus to refer based on the selected item. Menus depend only on the selected item itself, and other information such as the user profile are not taken into consideration.

### SUMMARY

Related art implementations do not take into consideration situations in which a user is placed or the time when the user would want to search related information. A user needs to add further information to specify “context”. This leads to deadlock during training phase because a trainee does not have enough knowledge or know sufficient technical terms to express “context” properly.

Maintenance workers may need to do many kinds of maintenance jobs in multiple domains. This requires much efforts and time to develop themselves. To develop their skill sets efficiently, there is a need for a supporting system to assist in learning across domains.

Example implementations described herein facilitate a system to allow users (e.g., technicians, trainees) to easily access appropriate technical materials required to perform a certain maintenance job. The example implementations described herein involve the following processes.

The system recognizes the user information and the maintenance job to do.

The system captures the user job profile and maintenance history for that user for all previous jobs done in the same or other domains (e.g., elevators, escalators, power generator, air conditioner, etc.)

Based on the user profile, job requirements, and previous maintenance experience in the same or other domains, the system recommends related materials (documents, pictures, videos, etc.) that could be fine-grained level or not.

Aspects of the present disclosure involve a method for facilitating a recommendation of materials to users, the method involving determining, from a job profile, a job experience level of a user for a job type and equipment type combination; determining, for each material in a database of materials, the job experience level associated with the each material based on an access log to the each material by one or more users and content of the each material to generate a material profile for each of the job experience level; and generating a recommendation of materials from the database for the user based on the determined job experience level of the user and the job experience level associated with the each material.

Aspects of the present disclosure involve a system for facilitating recommendation of materials to users, the system involving means for determining, from a job profile, a job experience level of a user for a job type and equipment type combination; means for determining, for each material in a database of materials, the job experience level associated with the each material based on an access log to the each material by one or more users and content of the each material to generate a material profile for each of the job experience level; and means for generating a recommendation of materials from the database for the user based on the determined job experience level of the user and the job experience level associated with the each material.

Aspects of the present disclosure involve a computer program, storing instructions for facilitating a recommendation of materials to users, the instructions involving determining, from a job profile, a job experience level of a user for a job type and equipment type combination; determining, for each material in a database of materials, the job experience level associated with the each material based on an access log to the each material by one or more users and content of the each material to generate a material profile for each of the job experience level; and generating a recommendation of materials from the database for the user based on the determined job experience level of the user and the job experience level associated with the each material. The computer program and instructions can be stored on one or more computer readable mediums such as non-transitory computer readable mediums and executed by one or more processes.

Aspects of the present disclosure involve an apparatus for facilitating a recommendation of materials to users, the apparatus involving a processor, configured to determine, from a job profile, a job experience level of a user for a job type and equipment type combination; determining, for each material in a database of materials, the job experience level associated with the each material based on an access log to the each material by one or more users and content of the each material to generate a material profile for each of the job experience level; and generate a recommendation of materials from the database for the user based on the determined job experience level of the user and the job experience level associated with the each material.

### BRIEF DESCRIPTION OF DRAWINGS

FIG. 1 illustrates an example problem involving materials access during worker training.

FIG. 2 illustrates an example overview of a recommendation system, in accordance with an example implementation.

FIG. 3(A) illustrates the details of maintenance knowledge sharing with recommendation system, in accordance with an example implementation.

FIG. 3(B) illustrates an example flow for job scoring based on historical counts, in accordance with an example implementation.

FIG. 3(C) illustrates an example flow for material scoring based on access logs, in accordance with an example implementation.

FIG. 3(D) illustrates an example flow of the recommendation algorithm, in accordance with an example implementation.

FIG. 4 illustrates an example of maintenance records, in accordance with an example implementation.

FIG. 5 illustrates examples of equipment and job type, in accordance with an example implementation.

FIG. 6 illustrates the details of example implementations for the job scoring shown in FIG. 3(B), in accordance with an example implementation.

FIG. 7 illustrates an example access log, in accordance with an example implementation.

FIG. 8 and FIG. 9 illustrates details for material scoring shown in FIG. 3(C), in accordance with an example implementation.

FIG. 10 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

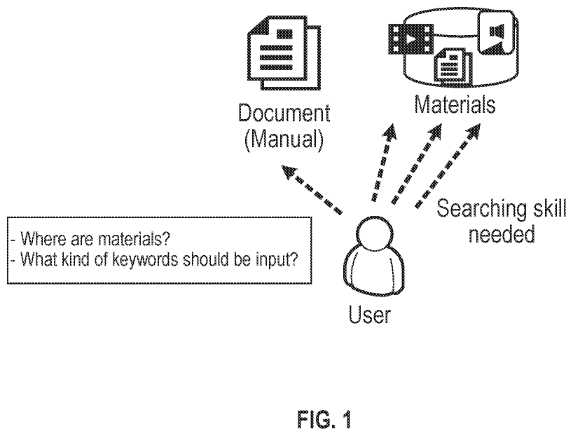

FIG. 1 illustrates an example problem involving materials access during worker training. Related art document reference systems output search results only based on information such as keywords specified by users. Such related art implementations can cause the following problems. Since the search results depend on the search skills of the users, users with poor search skills may not get the intended results. Further, since a uniform result is output regardless of the context in which the user is placed, extra efforts are needed by the user, such as determining whether unintentional results are provided, or whether the context should be additionally specified by keywords.

To address such issues in the related art, example implementations described herein provide a recommendation system of technical materials in which each maintenance worker may feel useful in his/her own context. Each maintenance worker can not only get appropriate technical materials without any keyword input for searching, but also reduce redundant materials and time consuming for checking results. In particular, the example implementations described herein involve a relational database involving materials (e.g., training materials, instruction manuals, etc.), job profiles of workers to identify worker skill levels for particular jobs (e.g., skill levels for job type/equipment type pair), access logs involving the materials by the workers, and job information (job type/equipment type pair) regarding the job performed. Through such a relational database, materials can be graded and associated to particular jobs and skill levels based on the workers who access the materials and their job experiences, and can be recommended when a user is looking for materials related to a particular job. Such relational databases provide a technological solution to the related art, which require precise keyword input to a search engine to obtain the appropriate materials due to the lack of relational context. Such precise keyword input may not be feasible for workers with lesser experience, who may not know the appropriate jargon to obtain the necessary materials.

In example implementations described herein, there are systems and methods that recognize the user information of the workers performing a maintenance job at a particular datetime. The systems and methods will capture the job profile and maintenance history of the user across all historical jobs conducted by the worker in the same domain or across different domains. This information is provided to a relational database as described herein to associate the technical materials accessed by such workers with the particular job domain, skill level, and so on, which can be referenced when another worker within a similar domain needs a recommendation for materials based on their skill level. The worker requesting a recommendation can login to the system, whereupon their job profile and maintenance history can be obtained and processed to determine the skill level across various job domains to provide context when retrieving appropriate materials for recommendation.

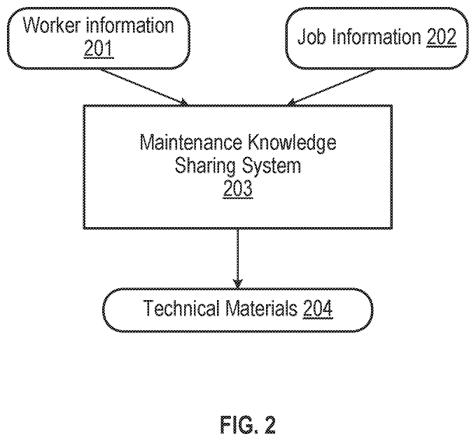

FIG. 2 illustrates an example overview of a recommendation system, in accordance with an example implementation. Maintenance knowledge sharing system 203 can output appropriate technical materials information 204 based on the information of the maintenance worker 201 and job information 202 of a job to be done by the maintenance worker.

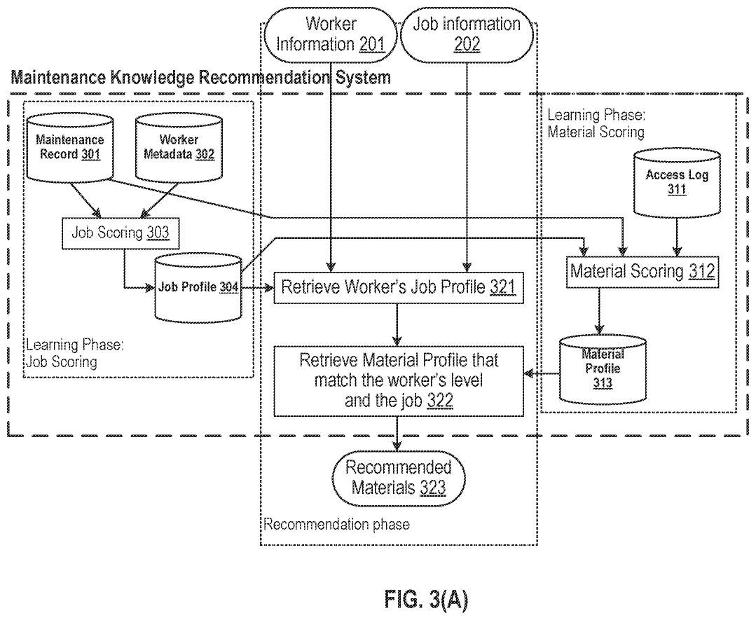

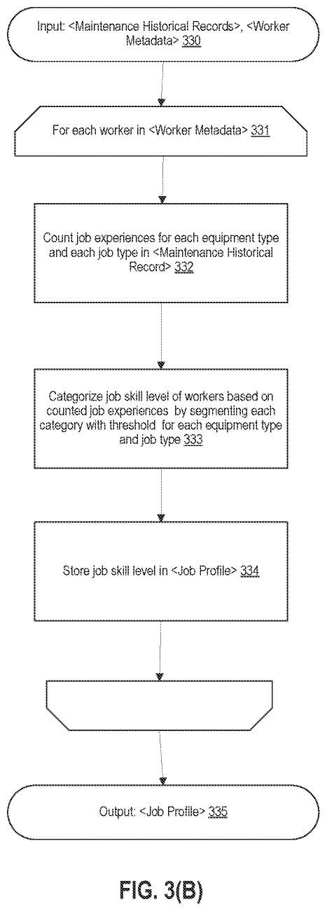

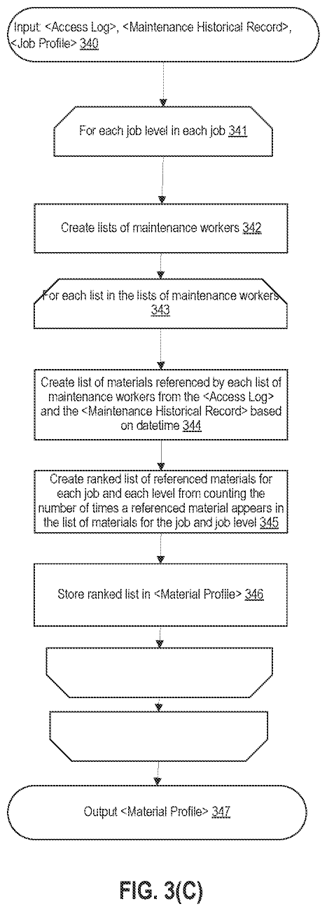

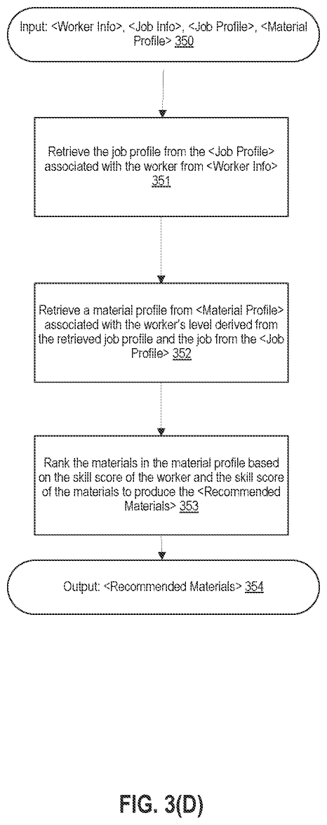

FIG. 3(A) illustrates the details of maintenance knowledge sharing with recommendation system, in accordance with an example implementation. The system involved two phases.

In the learning phase, there is job scoring 303 and material scoring 312. For the job scoring 303, the example implementations extract all the maintenance jobs from historical maintenance records 301 associated with each maintenance worker in the worker metadata 302 and assign for each maintenance worker a skill level score for each maintenance job based on their performance on historical jobs. The output of job scoring 303 is referred to as Job Profiles 304 which includes tuples of <maintenance worker, maintenance job, skill level>. The Job Profile 304 for each maintenance worker includes pairs of <maintenance job, skill level>. Further details of the job scoring 303 is provided in FIG. 3(B).

For material scoring 312, example implementations create a reference mapping of technical materials to a maintenance job skill level during the material scoring 312. This mapping is referred to as Material Profiles 313 which includes tuples of <material, maintenance job, skill level>. This mapping can be learned based on the content of the matching the semantics of the maintenance jobs with the contents of the materials or by mining the access records to these materials (e.g., access log 311) which show the skillset of users who used these materials in the past. Further details for the material scoring 312 is provided in FIG. 3(C).

In the recommendation phase, the system recommends technical materials at 323 based on the job profile of each maintenance worker 201 and the current job information 202 to be done. If the maintenance worker has different skill levels or different jobs to be done, the recommendation results will be different. From the worker information of the maintenance worker 201 and the current job information 202, the worker profile of the proposed maintenance worker is retrieved at 321. Based on the worker profile, the material profile that matches the proposed maintenance worker's job level for the particular job is obtained at 322, whereupon the recommended materials are provided at 323. The flow for the recommendation of materials in the recommendation phase is provided in FIG. 3(D).

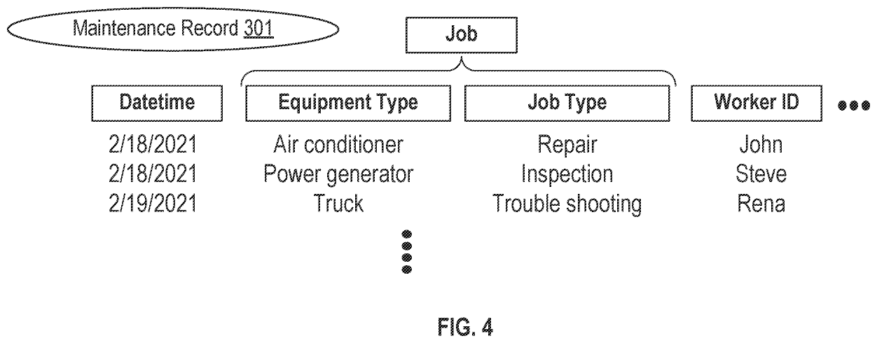

FIG. 3(B) illustrates an example flow for job scoring based on historical counts, in accordance with an example implementation. Specifically, FIG. 3(B) illustrates an example of the learning phase for job scoring. The input provided is the maintenance historical records 301 as illustrated in FIG. 4, and worker metadata 302 at 330. At 331, a loop is initiated for each worker Wᵢ in the worker metadata 302. At 332, the flow counts the number of job experiences C_{i,j,k} for each equipment type Eⱼ and each job type Tₖ in the maintenance historical records 301. At 333, the flow categorizes the job skill level L_{i,j,k} based on counted job experiences C_{i,j,k} by segmenting skill sets that meet a threshold θ_{j,k} into categories for each job type and equipment type. At 334, the categorized job skill levels are stored in job profile 304. At 335, the job profile 304 is provided as output.

FIG. 3(C) illustrates an example flow for material scoring based on access logs, in accordance with an example implementation. Specifically, the flow of FIG. 3(C) illustrates an example of the learning phase for materials discovery. At 340, the input involves the access log 311, the maintenance historical records 301, and job profile 304. At 341, a main loop is initiated for each job level L_{l,j,k} in each job. At 342, the flow creates lists of maintenance workers {W_{l,j,k}}.

At 343, for each list in the lists of maintenance workers w ∈ {W_{l,j,k}}, the flow creates lists of referenced materials {M_{w,l,j,k}} referenced by the maintenance workers in the each list w of maintenance workers from the access log 311 and the maintenance historical records 301 based on the datetime. At 344, the flow creates a ranked list {R_{l,j,k}} of referenced materials for each job and each level from the number of times the reference materials appears in the lists of referenced materials {M_{w,l,j,k}}. At 345, the flow then stores the ranked list {R_{l,j,k}} into the material profile 313. At 346, the output is thereby the material profile 313.

FIG. 3(D) illustrates an example flow of the recommendation algorithm, in accordance with an example implementation. Specifically, FIG. 3(D) illustrates an example of the recommendation phase. At 350, the input can involve worker information 201 of a particular worker, job information 202 of a current job to be done, job profile 304 and material profile 313. At 351, the flow retrieve the job profile L_{i,j,k} in job profile 304 associated with the worker w indicated in the worker information. At 352, the flow retrieves a material profile {R_{l,j,k}} in the material profile 313 associated with the worker's level l derived from the job profile L_{i,j,k} and the job j,k from the job information. At 353, the flow ranks the recommended materials {R_{l,j,k}} based on the skill score of the worker and the skill score of the materials. At 354, the flow provides the ranked recommended materials {R_{l,j,k}} as output.

FIG. 4 illustrates an example of maintenance records, in accordance with an example implementation. Maintenance records include datetime (e.g., time the job was conducted), job information, and worker information. Job information can involve the equipment type involved in the job and the job type of the maintenance job that was conducted. Worker information indicates the identifier (ID) of the maintenance worker that performed the job at the datetime.

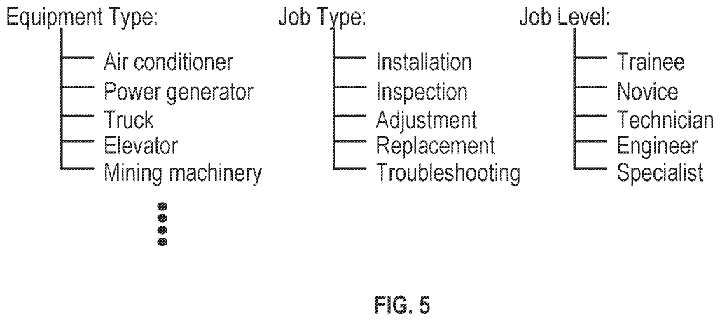

FIG. 5 illustrates examples of equipment and job type, in accordance with an example implementation. Equipment type can include any type of equipment that can undergo maintenance, such as, but not limited to, air conditioners, air compressors, power generators, vehicles, elevators, and so on. Job types can include any type of maintenance jobs such as installation, inspection, adjustment, replacement, troubleshooting, and so on. Job level can involve various levels to designate skill levels for a particular job for a given maintenance job type/equipment type combination, such as, but not limited to, trainee, novice, technician, engineer, and specialist to indicate the skill level from less skilled to more skilled.

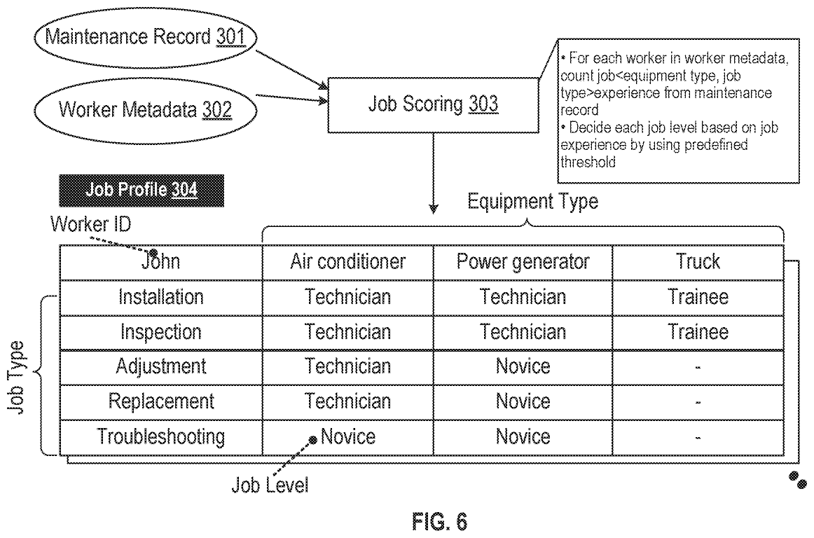

FIG. 6 illustrates the details of example implementations for the job scoring shown in FIG. 3(B), in accordance with an example implementation. Job scoring 303 evaluates the skill level of each maintenance worker in each job. Maintenance workers conduct maintenance work in multiple domains, so they can be required to learn about multiple equipment and maintenance job types associated with such equipment. Some maintenance job types are difficult to execute and need higher skill sets. Maintenance workers are rated according to their experience and skill sets and ranked as illustrated in FIG. 5. Job scoring 303 counts the worker's experience for maintenance operations from the maintenance records, and then determines the skill level of the worker based on each experience in each job (each equipment and each job type) and a pre-defined threshold that separate different skill levels. The example of FIG. 6 illustrates the maintenance worker “John” and corresponding skill levels for each equipment and each job type. Such information is stored as a job profile for the worker. The worker is assigned for appropriate job according to his skill levels.

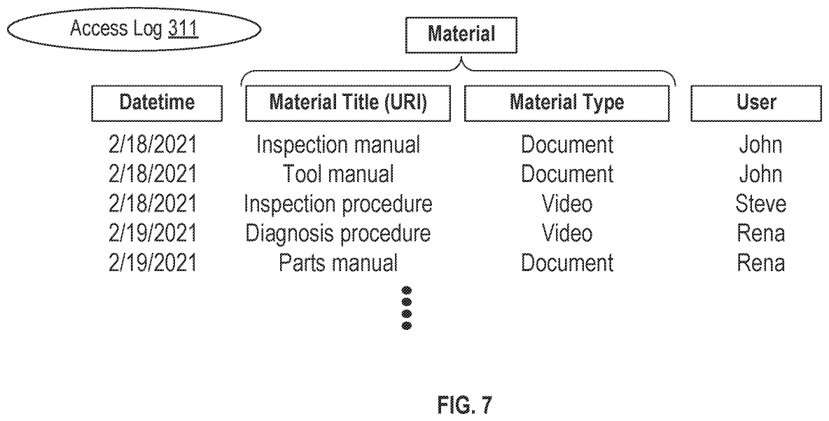

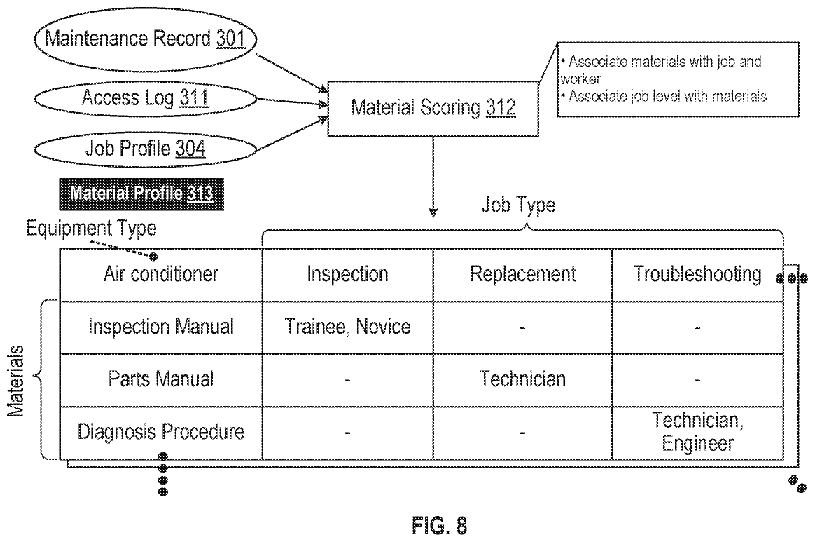

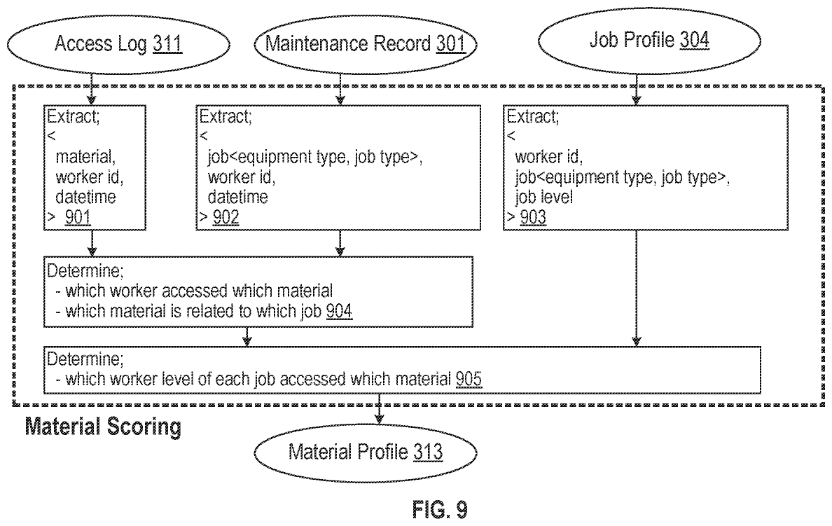

FIG. 8 and FIG. 9 illustrates details of material scoring shown in FIG. 3(C), in accordance with an example implementation. Material scoring 312 finds out useful materials which can be referred by maintenance workers in their maintenance job. At first, as shown in FIG. 8, material scoring uses an access log 311 such as the log shown in FIG. 7. Access log 311 includes the datetime of access, the corresponding materials accessed, and the user that conducted the access (maintenance worker). The materials accessed can involve the material title and the type of the material (e.g., document, video, etc.), along with corresponding links to the material. Then, material scoring 312 intakes maintenance records 301 to recognize which jobs are related to which materials by matching the access to the referenced materials with the datetime. After that, by connecting job profile information 304 to them by the worker identifier (ID) (e.g., the maintenance worker name), the material scoring 312 finds out which job and level are related to which materials. As a result, as shown in FIG. 7, by each job (each equipment and each job type), material scoring 312 can summarize which workers of various skill levels reference which materials. This information is stored as material profile 312.

In the recommendation phase shown in FIG. 3(D), the maintenance knowledge recommendation system can thereby provide material information recommended based on only a maintenance worker name and a job to be done. A job information can be brought from a maintenance schedule which is assigned to a maintenance worker.

In the example illustrated in FIG. 9, material, worker ID of the worker that accessed the material, and datetime of access are extracted from access log 311 at 901. Job information (job type/equipment type pair) of a job performed, worker ID of the worker who performed the job, and datetime of the job are extracted from maintenance record 301 at 902. The extracted information from 901 and 902 are used to determine which worker accessed which material while performing what job based on the datetime at 904. In this way, associations between worker ID, job being performed, and material accessed for a given datetime can be established.

Similarly, from the job profile 304, the material scoring 312 extracts the worker ID of the worker performing the job, the job information (job type/equipment type pair) of a job performed, and job level of the worker associated with the worker ID at 903. This extracted information is used in conjunction with the associations determined at 904 to determine what workers of what job levels access each particular material at 905. In this manner, job level and materials for a given job can be associated with each other.

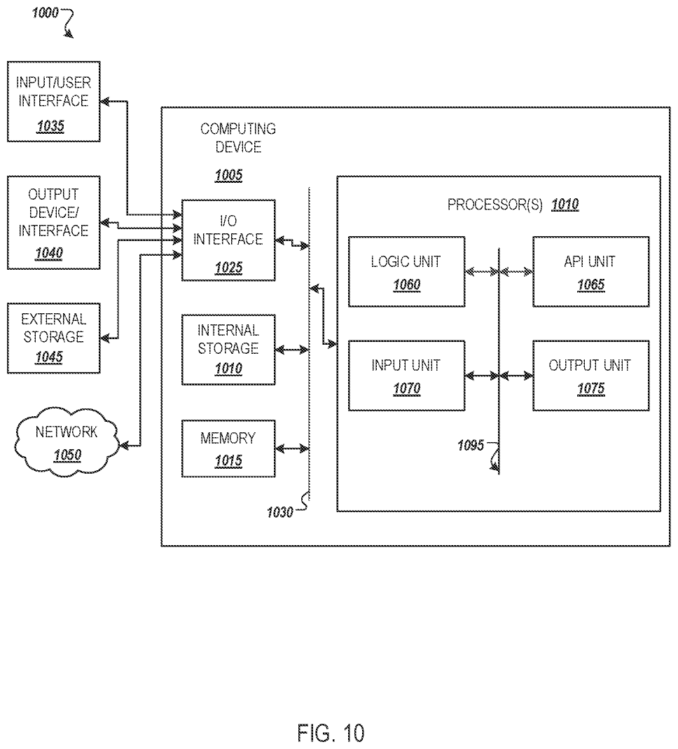

FIG. 10 illustrates an example computing environment with an example computer device suitable for use in some example implementations, such as an apparatus or platform to facilitate a recommendation of materials to users as illustrated in FIG. 2.

Computer device 1005 in computing environment 1000 can include one or more processing units, cores, or processors 1010, memory 1015 (e.g., RAM, ROM, and/or the like), internal storage 1020 (e.g., magnetic, optical, solid state storage, and/or organic), and/or I/O interface 1025, any of which can be coupled on a communication mechanism or bus 1030 for communicating information or embedded in the computer device 1005. I/O interface 1025 is also configured to receive images from cameras or provide images to projectors or displays, depending on the desired implementation.

Computer device 1005 can be communicatively coupled to input/user interface 1035 and output device/interface 1040. Either one or both of input/user interface 1035 and output device/interface 1040 can be a wired or wireless interface and can be detachable. Input/user interface 1035 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1040 may include a display, television, monitor, printer, speaker, braille, or the like. In some example implementations, input/user interface 1035 and output device/interface 1040 can be embedded with or physically coupled to the computer device 1005. In other example implementations, other computer devices may function as or provide the functions of input/user interface 1035 and output device/interface 1040 for a computer device 1005.

Examples of computer device 1005 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1005 can be communicatively coupled (e.g., via I/O interface 1025) to external storage 1045 and network 1050 for communicating with any number of networked components, devices, and systems, including one or more computer devices of the same or different configuration. Computer device 1005 or any connected computer device can be functioning as, providing services of, or referred to as a server, client, thin server, general machine, special-purpose machine, or another label.

I/O interface 1025 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1000. Network 1050 can be any network or combination of networks (e.g., the Internet, local area network, wide area network, a telephonic network, a cellular network, satellite network, and the like).

Computer device 1005 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1005 can be used to implement techniques, methods, applications, processes, or computer-executable instructions in some example computing environments. Computer-executable instructions can be retrieved from transitory media and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1010 can execute under any operating system (OS) (not shown), in a native or virtual environment. One or more applications can be deployed that include logic unit 1060, application programming interface (API) unit 1065, input unit 1070, output unit 1075, and inter-unit communication mechanism 1095 for the different units to communicate with each other, with the OS, and with other applications (not shown). The described units and elements can be varied in design, function, configuration, or implementation and are not limited to the descriptions provided.

In some example implementations, when information or an execution instruction is received by API unit 1065, it may be communicated to one or more other units (e.g., logic unit 1060, input unit 1070, output unit 1075). In some instances, logic unit 1060 may be configured to control the information flow among the units and direct the services provided by API unit 1065, input unit 1070, output unit 1075, in some example implementations described above. For example, the flow of one or more processes or implementations may be controlled by logic unit 1060 alone or in conjunction with API unit 1065. The input unit 1070 may be configured to obtain input for the calculations described in the example implementations, and the output unit 1075 may be configured to provide output based on the calculations described in example implementations.

Processor(s) 1010 can be configured to determine, from a job profile, a job experience level of a user for a job type and equipment type combination; determine, for each material in a database of materials, the job experience level associated with the each material based on an access log to the each material by one or more users and content of the each material to generate a material profile for each of the job experience level; and generate a recommendation of materials from the database for the user based on the determined job experience level of the user and the job experience level associated with the each material as illustrated in FIGS. 1, 2, and 3(D).

Processor(s) 1010 can be configured to generate the job profile of the user, the job profile involving the job experience level of the user for the job type and the equipment type combination, by determining, from a maintenance record, a number of job experiences for each equipment type and each job type for the user; categorizing the job experience level based on the number of j ob experiences for combinations of the each equipment type and the each job type; and storing the job experience level in the job profile as illustrated in FIGS. 3(A) and 3(B).

Processor(s) 1010 can be configured to determine, for the each material in the database of materials, the job experience level associated with the each material based on the access log to the each material by the one or more users and the content of the each material by generating a list of users for each of the job experience level of each of the job type and the equipment type combination from the user profile of the one or more users, for each user in the list of users, generating a list of materials referred to by the each user from the access log and a maintenance record; creating a ranked list of referred materials for the each job type and the job experience level from the list of materials referred to by the each user; and storing the ranked list of referred materials in a materials profile as illustrated in FIGS. 3(A), 3(B) and 8.

Processor(s) 1010 can be configured to generate the recommendation of materials from the database for the user based on the determined job experience level of the user and the job experience level associated with the each material by retrieving a material profile associated with the determined job experience level of the user; and ranking materials in the material profile based on the determined job experience level of the user and an associated skill score of each of the materials to generate the recommended materials as illustrated in FIG. 3(D).

In example implementations, the job experience level is selected from a plurality ofjob experience levels, each of the job experience levels representative of a threshold number of times the user has operated on the job type and the equipment type combination as illustrated in FIG. 6.

In example implementations, the job type is indicative of a maintenance operation as illustrated in FIG. 5.

In example implementations, the material profile indicates, for the each material, the determined job experience level for the job type and the equipment type combination; wherein the each material is a document or media content of a manual or procedure associated with the equipment type as illustrated in FIG. 9.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for facilitating a recommendation of materials to users, the method comprising:
determining, from a job profile, a job experience level of a user for a job type and equipment type combination;
determining, for each material in a database of materials, the job experience level associated with the each material based on an access log to the each material by one or more users and content of the each material to generate a material profile for each of the job experience level; and
generating a recommendation of materials from the database for the user based on the determined job experience level of the user and the job experience level associated with the each material.

2. The method of claim 1, further comprising generating the job profile of the user, the job profile comprising the job experience level of the user for the job type and the equipment type combination, the generating the job profile comprising:
determining, from a maintenance record, a number of job experiences for each equipment type and each job type for the user;
categorizing the job experience level based on the number of job experiences for combinations of the each equipment type and the each job type;
storing the job experience level in the job profile.

3. The method of claim 1, wherein the determining, for the each material in the database of materials, the job experience level associated with the each material based on the access log to the each material by the one or more users and the content of the each material comprises:
generating a list of users for each of the job experience level of each of the job type and the equipment type combination from the user profile of the one or more users;
for each user in the list of users:
generating a list of materials referred to by the each user from the access log and a maintenance record;
creating a ranked list of referred materials for the each job type and the job experience level from the list of materials referred to by the each user; and
storing the ranked list of referred materials in a materials profile.

4. The method of claim 1, wherein the generating the recommendation of materials from the database for the user based on the determined job experience level of the user and the job experience level associated with the each material comprises:
retrieving a material profile associated with the determined job experience level of the user;
ranking materials in the material profile based on the determined job experience level of the user and an associated skill score of each of the materials to generate the recommended materials.

5. The method of claim 1, wherein the job experience level is selected from a plurality of job experience levels, each of the job experience levels representative of a threshold number of times the user has operated on the job type and the equipment type combination.

6. The method of claim 1, wherein the job type is indicative of a maintenance operation.

7. The method of claim 1, wherein the material profile indicates, for the each material, the determined job experience level for the job type and the equipment type combination;
wherein the each material is a document or media content of a manual or procedure associated with the equipment type.

8. A non-transitory computer readable medium, storing instructions for executing a process for facilitating a recommendation of materials to users, the instructions comprising:
determining, from a job profile, a job experience level of a user for a job type and equipment type combination;
determining, for each material in a database of materials, the job experience level associated with the each material based on an access log to the each material by one or more users and content of the each material to generate a material profile for each of the job experience level; and
generating a recommendation of materials from the database for the user based on the determined job experience level of the user and the job experience level associated with the each material.

9. The non-transitory computer readable medium of claim 8, further comprising generating the job profile of the user, the job profile comprising the job experience level of the user for the job type and the equipment type combination, the generating the job profile comprising:
determining, from a maintenance record, a number of job experiences for each equipment type and each job type for the user;
categorizing the job experience level based on the number of job experiences for combinations of the each equipment type and the each job type;
storing the job experience level in the job profile.

10. The non-transitory computer readable medium of claim 8, wherein the determining, for the each material in the database of materials, the job experience level associated with the each material based on the access log to the each material by the one or more users and the content of the each material comprises:
generating a list of users for each of the job experience level of each of the job type and the equipment type combination from the user profile of the one or more users;
for each user in the list of users:
generating a list of materials referred to by the each user from the access log and a maintenance record;
creating a ranked list of referred materials for the each job type and the job experience level from the list of materials referred to by the each user; and
storing the ranked list of referred materials in a materials profile.

11. The non-transitory computer readable medium of claim 8, wherein the generating the recommendation of materials from the database for the user based on the determined job experience level of the user and the job experience level associated with the each material comprises:
retrieving a material profile associated with the determined job experience level of the user;
ranking materials in the material profile based on the determined job experience level of the user and an associated skill score of each of the materials to generate the recommended materials.

12. The non-transitory computer readable medium of claim 8, wherein the job experience level is selected from a plurality of job experience levels, each of the job experience levels representative of a threshold number of times the user has operated on the job type and the equipment type combination.

13. The non-transitory computer readable medium of claim 8, wherein the job type is indicative of a maintenance operation.

14. The non-transitory computer readable medium of claim 8, wherein the material profile indicates, for the each material, the determined job experience level for the job type and the equipment type combination;
wherein the each material is a document or media content of a manual or procedure associated with the equipment type.

15. An apparatus, configured to facilitate a recommendation of materials to users, the apparatus comprising:
a processor, configured to:
determine, from a job profile, a job experience level of a user for a job type and equipment type combination;
determine, for each material in a database of materials, the job experience level associated with the each material based on an access log to the each material by one or more users and content of the each material to generate a material profile for each of the job experience level; and
generate a recommendation of materials from the database for the user based on the determined job experience level of the user and the job experience level associated with the each material.
